(19) United States
(12) Patent Application Publication
(10) Pub. No.: US 2010/0031555 A1
(43) Pub. Date: Feb. 11, 2010

(54) Animal Trap

(76) Inventors: Gabriel Le Laidier, St. Gellen (CH); Dennis Walstad, Elburn, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/310,501

(22) PCT Filed: Jul. 4, 2007
(86) PCT No.: PCT/EP2007/056768

§ 371 Date: Jul. 7, 2009

(30) Foreign Application Priority Data
Sep. 1, 2006 (EP) 06119958.4

(51) Int. Cl. A01M 23/24

(52) U.S. Cl. 43/77

(57) ABSTRACT

An animal trap (1) for catching voles dwelling in underground tunnels comprises a housing (2) provided with two openings (11). A closing part (3) which can be moved between a closed position and an open position is mounted in the housing and has a front edge (10) for applying a, preferably fatal, closing force to a vole, wherein the closing part (3) can be held in the open position under spring preloading by means of a retaining arrangement. The closing part (3) can be moved from the closed position into the open position such that on reaching the open position, the closed part (3) is automatically locked by way of the retaining arrangement, which is operatively connected to the triggering mechanism. When the vole enters the opening, the triggering mechanism activates to trigger the closing movement of the closing part (3).

The invention comprises an animal trap of the generic type shown in claim 1. This type of trap is for catching burrowing animals, especially voles, water voles and also field mice.

Traps used for voles living under the surface have long been in common use. An example of a comparable trap of the same type is described in WO 03/061375. The trap described there shows a cylindrical housing, which has two openings on the underside which can be placed in a tunnel. In this housing is a hollow, tubular (or cylindrical), closing part, which is placed in the housing and slides lengthways so that in the closed position the opening is blocked. When setting the trap it must be placed in the vole tunnel so that the tunnel is clear to allow the mouse to pass through the openings. At the lower part of the trap is a trigger pin, which is mounted inside the housing and which swivels about a trigger spindle which extends lengthways. The end of the triggering pin furthest from the trigger spindle is U-shaped. The furthest point of the U-shaped end holds in place the rocker which is joined to the closing part. The rocker is swivel-linked to a loading handle on the closing part. To set the trap, (i.e. to place it in the open position), the clamp lever must first be pulled up with the rocker. The rocker is then pressed against the housing cover and finally the tip of the U-shaped end of the trigger is placed on the rocker, thus holding the closing part in the open position. This trap is difficult to operate. Furthermore it has been shown in practise that the use of coil springs to tension the closing part is undesirable.

It is therefore an aim of this invention to avoid the disadvantages of the known design and to create a trap of the type in question, characterised by simple operation.

In terms of design, the aim will be met with a trap which incorporates the features in claim 1. The closing part moves from the closed position to the open position in such a way that when the open position is reached, it self locks with the help of a triggering mechanism with a snap catch fastening. To set the trap only the closing part needs to be moved. The trap is locked open automatically without the need for further actions. The ability to self lock assures the simple operation of the trap. The closing part is moved chiefly by sliding. When the trap closes the animal receives a blow from the front edge, which is preferably lethal. Depending on the animals being trapped, an appropriate spring configuration is envisaged with which a sufficient closing force is achieved.

In a first version the closing part is locked open with a snap catch in the housing. With such a snap catch design a self-lock is simply achieved.

The snap catch design requires at least one retaining member on the closing part, which is supported by a shoulder on the triggering mechanism. With this design it becomes very easy to achieve a good lock of the closing part in the open position.

It is also advantageous to have a triggering mechanism with a swivel-mounted triggering part in the housing, where the swivel axis is offset, or at right angles to the direction of movement of the closing part. The triggering part is a unit which extends along the direction of movement. By this simple and reliable method, the animal disturbs the front end of the part, which swivels and triggers the trap. With this design it is impossible for parts to be missed from the triggering mechanism, like for example the trigger pin used in the WO 03/061375. A triggering failure is therefore practically impossible.

Of particular merit is a triggering mechanism containing a triggering part with at least one lead-in face, along which the locking member can be moved during opening. In this way the triggering part is swivelled by sliding the closing part into the open position.

The triggering mechanism consists of a triggering part with support members, in which the upper end of the support member acts as a support shoulder in the direction of opening.

It is of particular advantage that the triggering part contains a support element with support members configured with single rather than double spacing. In this way a guide channel is created between the support members, in which the retaining element can be routed. In addition there is a wedge shaped lead-in along the guide channel, running in direction of opening. This design insures a good interface between the retaining member and the support element.

The support members form an arrowed support element in the direction of opening, the surfaces of which form external lead-in faces. This way the retaining element can move externally on the arrow surfaces and internally on the guide channel.

It is an advantage if the closing part has a handle which protrudes from the housing, and with which the closing part is moved to the open position. The action of opening is thus made easy by manually gripping the handle. The handle protrudes from the housing at different lengths in the open and closed positions. It is therefore easy to see if the trap has been actuated or not. For example a long handle protruding from the housing (closing part in the open position), would indicate that the no animal has yet been caught. This visual management could be further strengthened through the use of colours on the handle.

The closing part can be produced as a single plastic injection moulded component. Such a closing part is simple and cost effective to make.

Regarding the spring preloading, a coil spring for example, or many coil springs could be used. However the inclusion of at least one torsion spring is considered a particular advantage. Thanks to its non-linear spring force distribution, a torsion spring has advantages in the processes of opening and closing, both in terms of operation and trapping effectiveness.

The idea of one torsion spring for each side of the triggering part creates advantages. With this type of arrangement one-sided spring action is avoided.

To support each of the torsion springs a spring holder in the triggering part is foreseen, where holders for spring pairs may or may not be displaced from one another.

The edge is formed by the front end of a wall section, which blocks the opening in the closed position. As, in general, the animal must be killed for a successful outcome, a relatively shorter edge section could instead be chosen, which only partially blocks the opening, or not at all.

The housing comprises two openings, located opposite one another. The wall section can be further developed, along the lines of a hollow cylinder, where both openings are blocked in the closed position. However, the closing part obviously cannot be formed entirely as a hollow cylinder.

Instead it is better if only the front end is designed as a hollow cylinder for the wall section and that an extended connecting part is added along the line of movement, (i.e. the direction of opening). The top end of this connecting part forms the handle. The connecting part could for example be a rectangular section with a rectangular cross section. Other profile forms could also be chosen.

For a guaranteed kill, it is better to design the edge of the closing part with a wedge-shaped cross section. This is especially advantageous if the edges are relatively thick in cross section, i.e. with a large wall thickness. As a rule however the wedge should not be sharp as it is not desirable to cause cuts. Dismembering of the animal is not desirable for hygiene reasons.

On the floor of the opening a circular floor section is envisaged, which, at least in the closed position, is offset inwards relative to the closing element, so that the edge of the closing part overlaps the floor section,—at least in part. In addition it would be possible here to define the front end of the floor section facing the closing part, with a wedge-shaped cross section.

The housing can be developed as a hollow cylinder,—at least the lower part. The housing has a cylindrical cover. The floor section can then be offset inwards of the housing cover when looking from above, so that the edge lies between the housing cover and the floor section.

For process and cost reasons plastic should be specified for the housing and/or the closing part.

Further advantages and individual features of the invention are found in the drawings and in the following description of working examples.

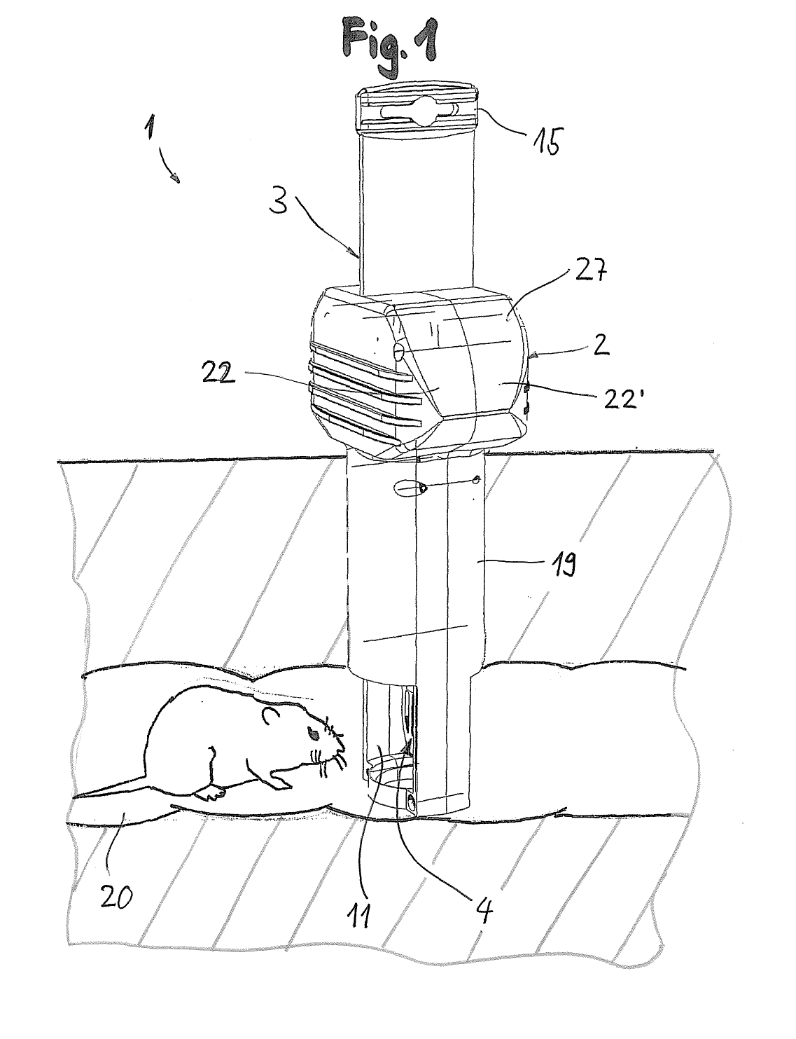

FIG. 1 A perspective view of a below-surface animal trap design, intended for voles,

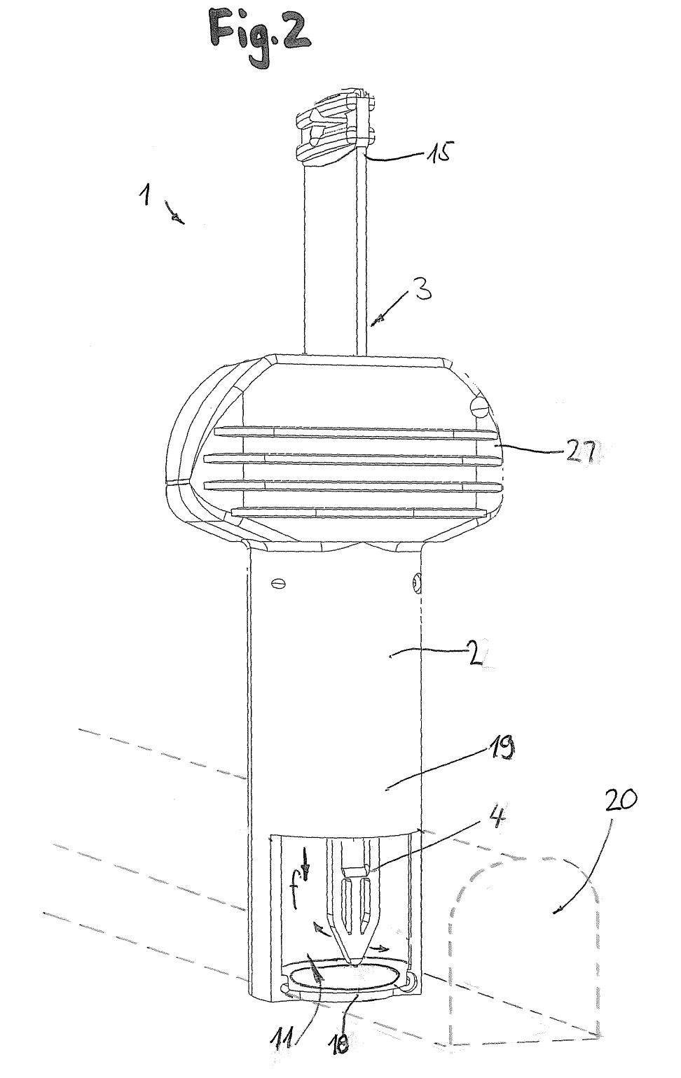

FIG. 2 A view of the trap described in FIG. 1 in the open position, from a different angle,

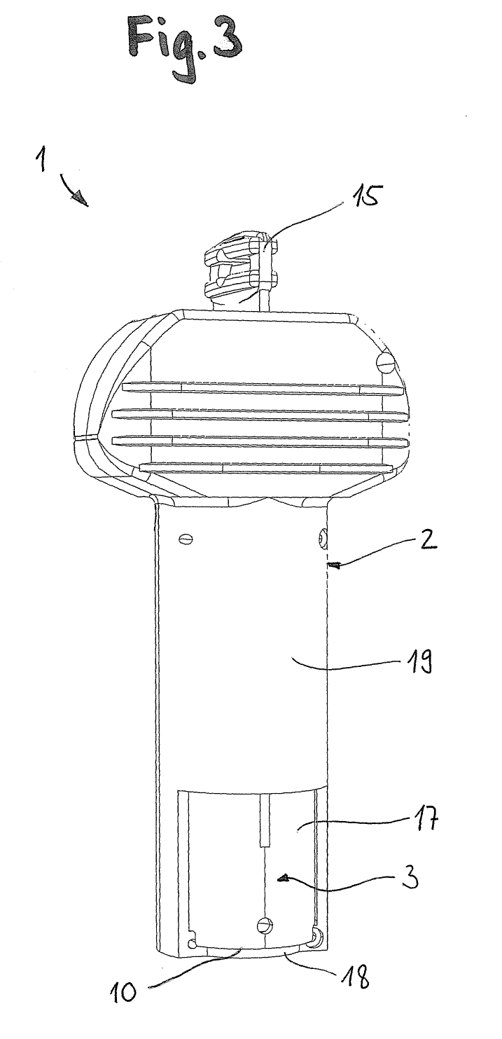

FIG. 3 The trap as in FIG. 2, in the closed position,

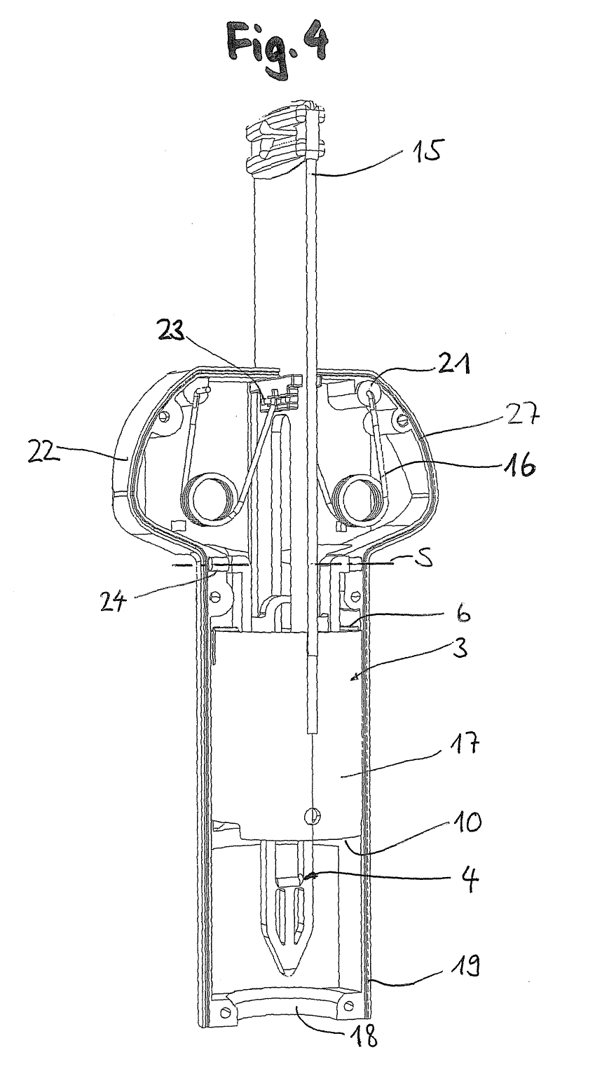

FIG. 4 The trap as in FIG. 2, with the housing cover dismantled,

FIG. 5 The trap as in FIG. 3, with the housing cover dismantled,

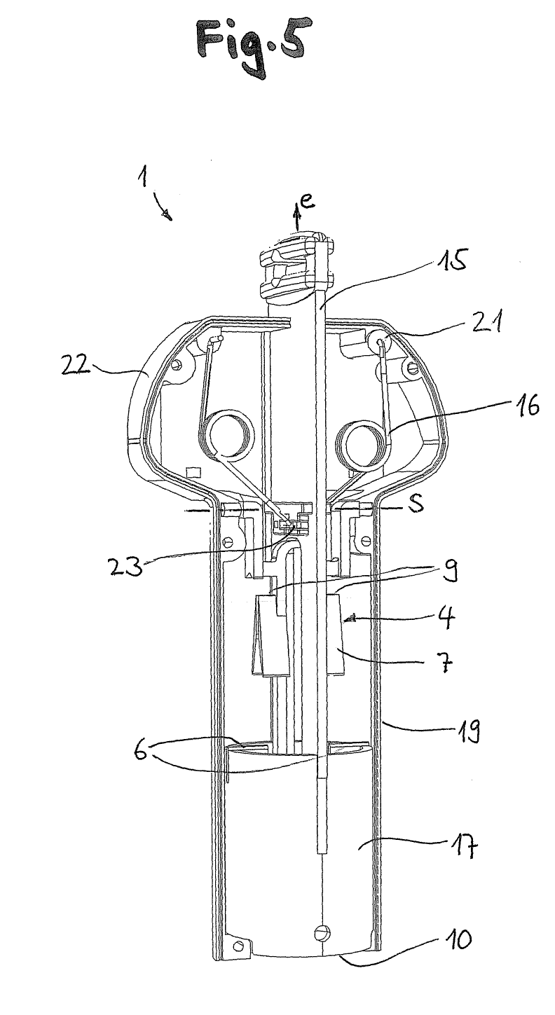

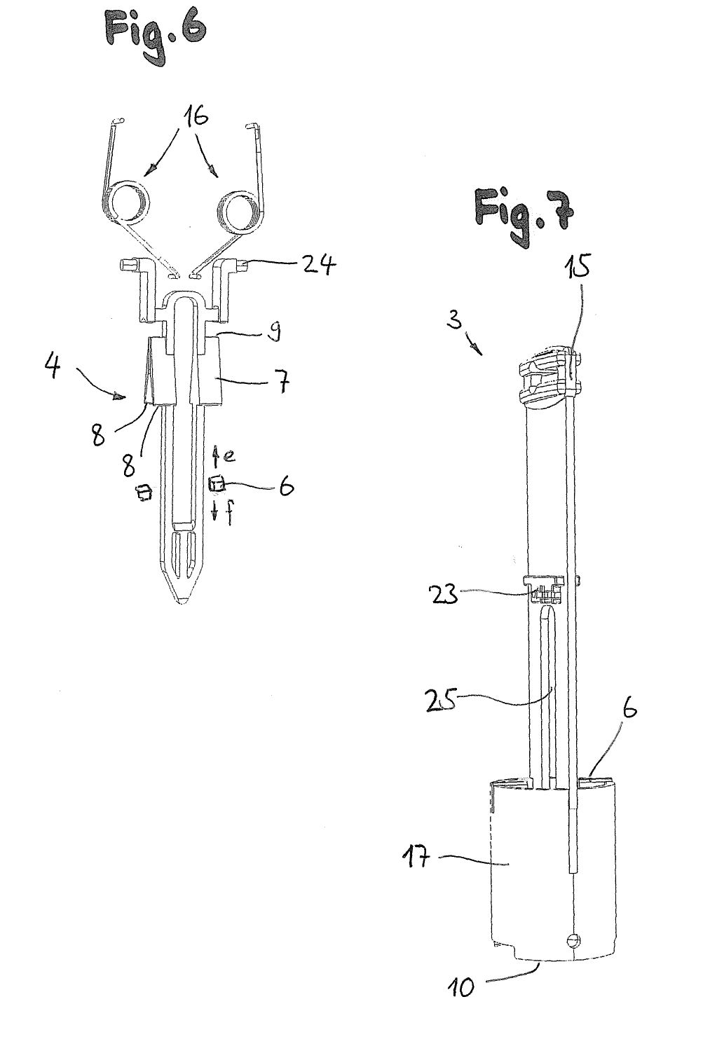

FIG. 6 A perspective view of the trap's triggering part and a pair of torsion springs,

FIG. 7 A perspective view of the trap's closing part,

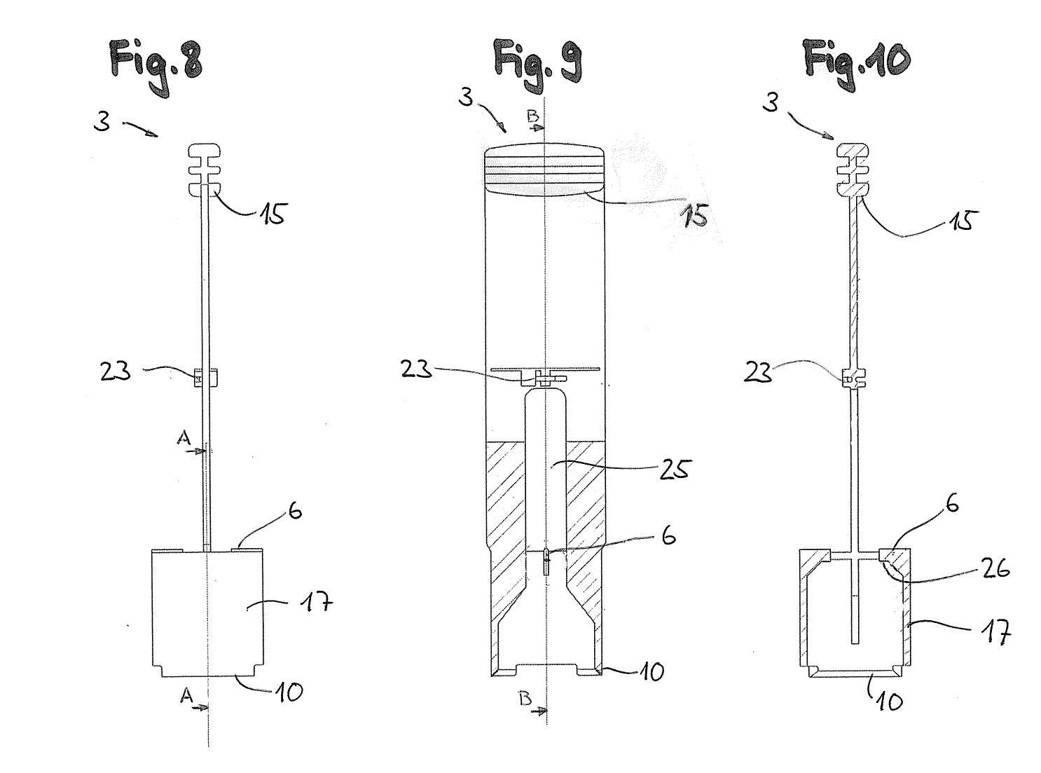

FIG. 8 A side view of a closing part with a slight modification relative to FIG. 7,

FIG. 9 A front view of the closing part as in FIG. 8, with a section (Section A_A, in FIG. 8),

FIG. 10A section through the length of the trap (Section B_B in FIG. 9),

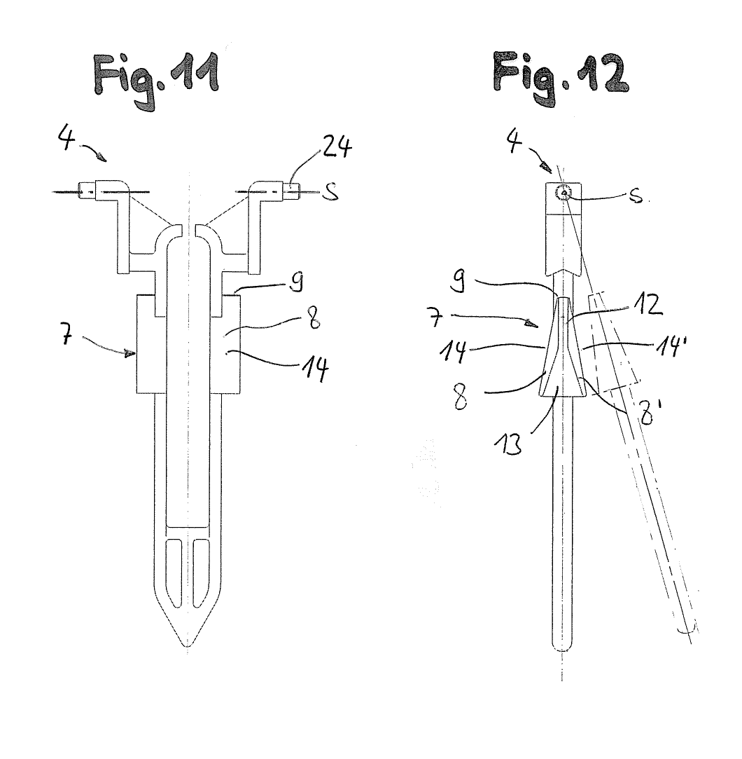

FIG. 11 A front view of the triggering part in FIG. 6, and

FIG. 12 A side view of the closing part in FIG. 11.

FIG. 1 shows a mark 1 animal trap, in field conditions. This trap has a Housing 2 with openings 11, to which an underground tunnel 20 is fitted where the tunnel passes through the opening. This type of tunnel is used for voles for example. By design the traps are also suitable for other animals. It can also be seen in FIG. 1 that the housing is made of two parts and is consists of housing shells 22 and 22′ The housing contains a cylindrical part which is housing cover 19 at the bottom and the head part 27 above ground. The exact working method of the trap is detailed in FIGS. 2 to 5.

As seen in FIG. 2, at the bottom there are opposite facing openings 11 in cylindrical part 19 of the housing. The front end of trigger part 4 clearly protrudes from tunnel 20. When disturbed by the animal, trigger part 4 triggers the closing movement of closing part 3 in the “f” direction. Closing part 3 is located in the housing and is moveable along the closing line f. Trigger part 4, which can be swivelled, is located in the housing. The swivel directions are indicated by curved arrows. In FIG. 2, handle 15 is recognisable protruding from closing part 3.

In the closed position, the opening is clearly blocked by wall section 17 of closing part 3. Closing part 3 has a front edge 10, which exerts a closing force on the animal through the closing motion.

The animal is thus dealt a deadly blow. In order to apply the closing force a spring arrangement is envisaged for the trap (compare FIGS. 4 & 5).

On the floor of opening 11 a circular floor section is foreseen. Based on FIGS. 2 and 3 it is apparent that in the closed position, floor section 18 is set inwards of edge 10, such that in parts edge 19 overlaps floor section 18. In a plan view (not shown here), in the same way, floor section 18 is set inwards of housing 19 in such a way that edge 10 sits between housing 19 and floor section 18.

The spring arrangement is shown in FIGS. 4 and 5. The following working example shows a spring arrangement comprising a pair of torsion springs 16. Spring 16 is secured in each case by a holder 21 on housing 2 and by a holder 23 on closing part 3. In this way closing part 3 is kept under preloading by the snap catch in the open position.

Housing 2 consists of 2 halves, which can be divided along their length. A single housing shell part 22 is shown in FIGS. 3 and 4. Here also fixing holes are shown, which together serve to join the housing shell parts. The head part 27 of the housing incorporates the torsion springs. FIG. 4 also shows that the front end of floor section 18 on the side of the closing part has a wedge-shaped cross section.

As shown in FIG. 4, triggering part 4 swivels about axis S in the housing. Axis S clearly runs at right angles to the direction of movement of closing part 3. To achieve the swivel movement, axel stubs 24 are foreseen, which are mounted in the corresponding sockets in the housing.

In Trap 1's closed position in FIG. 5 some design details can be seen of the spring arrangement for holding the closing part in the open position. There are 2 support elements located opposite one another on triggering part 4. On the upper end of support elements 7 support shoulders 9 can be seen, to which 6 retaining elements 6 of closing part 3 are fitted (as illustrated in FIGS. 9/10). In FIG. 4 the retaining elements 6 are only partly visible as they are inserted deep into wall section 17. Triggering part 4 contains the lead-in faces associated with support element 7, along which retaining element 6 is moved when opening.

From FIG. 6 it can be seen that each support element consists of 2 support parts 8. On the upper end of support part 8 is a support shoulder 9. With the opening movement indicated by arrow e, the retaining member is guided along the lead-in faces. On reaching the opening position the support shoulders act as stops. In this position the closing part is locked by a snap catch.

FIG. 6 also shows the torsion springs in the closed position. The spring ends are bent in such a way that they lie roughly parallel to the swivel plane of the triggering part.

A spring end bent in this way sits conveniently in closing part 3, (as in FIG. 7)

FIG. 7 shows the dismantled closing part 3. Closing part 3 has a hollow, cylindrical wall section 17 which forms the lower end of the part. To this a flat section locks in, which lies in along the opening line, the end of which is forms handle 15. At about the centre, spring holder 23 is shown, into which the bent end of the torsion spring is fitted. A slot 25 is foreseen between wall section 17 and spring holder 23, which forms two arms. The triggering part is located in recess 25, between the arms. This allows at least a slight swivel movement. Closing part 3 can be specified as a single, injection moulded part.

As shown in FIGS. 8 to 10, closing part 3 differs from the previous working example only due to modified spring holders 23 and a different shaped handle 15. It can be seen from FIG. 9 that edge 10 of the closing part is wedge shaped. In FIG. 10 the form of the retaining member 6 is clear to see. The retaining member is a component which points inwards from the hollow cylinder of the wall section, and forms the retaining face 26. This retaining face 26 acts as a stop face for the support shoulders in the open position.

In FIGS. 11 and 12 the exact characteristics of triggering part 4 are shown. Support members 8, 8′ form support element 7, arrowed along the opening line, whereby the arrow faces 14, and 14′ form external guides. The support elements' single spaced support members 8, 8′ form the guide channel 12, through which the retaining member moves.

Running from the guide channel 12 along the direction of opening is a wedge shaped lead-in section 13. Support element 7 therefore has outer and inner guide surfaces (12, 13 and 14), along which the retaining member moves. In the open position a retaining member (not shown here), sits on support shoulder 9 and, as such, prevents the closing part from moving back into the closed position. When triggered, triggering part 4 swivels so that the retaining member is released, causing the closing part to move by the spring mechanism force to the closing position. The trigger part is shown in FIG. 12 as a dotted outline in the described swivel position.

1. Animal trap (1) for trapping underground burrowing animals, especially voles, to include
A housing (2), with at least 1 opening (11), which is placed in a tunnel (20), where the tunnel is at least partially clear,
A closing part (3) which is moveable between a closed and an open position, with a front edge (10) which exerts a lethal closing force on the animal, in which the closing part (3) is held in the open position, under spring preloading by a snap catch mechanism, and
A triggering mechanism which is activated when disturbed by the animal and which triggers the closing movement of the closing part (3),
characterised by the closing part being moveable from the closed to the open position in such a way that on reaching the open position the closing part (3) is automatically locked with the aid of triggering mechanism, in conjunction with the snap catch design.

2. Animal trap according to claim 1, characterised by a closing part (3) which is locked in the open position by a snap catch in the housing (2).

3. Animal trap according to claim 1, characterised by a snap catch arrangement (5), with at least one retaining member on the closing part (3), which is supported by a support shoulder of the triggering mechanism.

4. Animal trap according to claim 3, characterised by a triggering mechanism, with a swivel triggering part (4), mounted in the housing with a swivel axis which is offset from the line of movement of the closing part.

5. Animal trap according to claim 3, characterised by a triggering mechanism with a triggering part (4), which features at least one guide face (12, 13, 14), along which the retaining element travels in both the opening and closing directions.

6. Animal trap according to the claim 1, characterised by a closing part (3) with a handle (15) which protrudes from the housing (2) and helps to position the closing part (3) in the open position.

7. Animal trap according to the claim 1, characterised by a single injection moulded component for the closing part (3).

8. Animal trap according to the claim 1, characterised by at least one torsion spring (16) for applying spring preloading.

9. Animal trap according to the claim 1, characterised by a closing part (3), with an edge (10) which has a wedge shaped cross section.

10. Animal trap according to the claim 1, characterised by a circular floor section (18) at the lower part of the opening (11), which, at least in the closed position, sits inwards of edge (10) of the closing part (3), and where edge (19) at least partly overlaps floor section (18).

11. Animal trap according to the claim 1, characterised by a housing (2) and/or closing part (3) made from plastic.
